(19) United States
(12) Patent Application Publication
(10) Pub. No.: US 2002/0168975 A1
(43) Pub. Date: Nov. 14, 2002

(54) System and method for airborne passenger electronic communication

(75) Inventors: Simon I. Gresham, Seattle, WA (US); Nathanael E. Moore, Auburn, WA (US); Peter W. Lemme, Kirkland, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Tenzing Communications, Inc., Seattle, WA

(21) Appl. No.: 10/112,300

(22) Filed: Mar. 28, 2002

Related U.S. Application Data
(60) Provisional application No. 60/280,311, filed on Mar. 29, 2001.
(60) Provisional application No. 60/280,334, filed on Mar. 29, 2001.

(51) Int. Cl. G06F 15/16

(52) U.S. Cl. 455/431; 709/206

(57) ABSTRACT

An electronic communication system for use onboard an aircraft includes a server and a plurality of input ports for connection with passenger computing devices. Passengers can send and retrieve electronic messages (e-mail and/or attachments) using a proxy-based web server access to the user's own e-mail service provider. The system receives proxy-based commands from the user's computing device and translates those commands into web-based commands that enable communication with the passenger's e-mail accounts. The passenger may send e-mail communications by composing a message on the passenger computing device and sending it via the web-based proxy server. E-mail messages may also be retrieved from one or more passenger e-mail accounts. In one embodiment, the system transmits only e-mail summary information to the airborne server and provides the summary information to the passenger. The passenger may select one or more e-mails and/or attachments for subsequent retrieval, thus limiting passenger expense for retrieval of unwanted or unnecessary e-mails and/or attachments. The system may also display cost information associated with uploading the e-mail and/or attachments to enable the passenger to select those desired messages for subsequent transmission.

### BACKGROUND OF THE INVENTION

1. Field of the Invention

The present invention is related generally to electronic communication and, more particularly, to a system and method for passenger electronic communication while in an aircraft.

2. Description of the Related Art

A passenger may not be able to use airborne e-mail services because the passenger's company may limit (for security reasons) the protocols with which the passenger can access e-mail services from outside the company's firewall. Also, the passenger may not be able to use airborne e-mail services because the passenger's configuration of the e-mail client may not be supported. Further, if the passenger's e-mail client is incompatibly configured, then the passenger may have a poor experience when using the airborne e-mail service. Moreover, the passenger may have e-mail accounts on multiple types of e-mail servers, but in order to access them, the passenger may be required to switch between e-mail clients and/or e-mail client configurations.

When configuring an e-mail server, the configuring authority has many options from which to choose. One option pertains to the protocols with which an e-mail server can be accessed from outside the company. A commonly encountered scenario is as follows. The e-mail server is configured such that one or more proprietary and/or non-published protocols (e.g., MAPI for Microsoft Exchange servers; Lotus Notes for Lotus Notes servers; Groupwise for Novell servers) are accessible via the internet using a standard web browser. When an e-mail server is web access enabled (a.k.a. web enabled), it means that when the passenger is outside the company, a standard web browser (e.g., Microsoft Internet Explorer, Netscape) can be used to access the e-mail services.

An airborne communication system that provides e-mail services and interfaces with various e-mail software programs and servers in the marketplace faces the challenge of being compatible with multiple makes, versions, and configurations of e-mail servers and their associated software programs. These three variables form a large three-dimensional matrix of possibilities that is constantly growing, as manufacturers of e-mail software programs frequently release updates to existing versions and new versions (and each updated version and new version potentially alters the configuration options), of their products. To accommodate this large three-dimensional array of possibilities, a practical approach for an airborne communication system is to be compatible with the e-mail software programs of the most common make, version, and configuration combinations, hereafter called “common configurations.” However, with this approach, there will be not-so-common combinations of make, version, and configuration, hereafter called “fringe configurations,” with which the airborne communication system will not be compatible.

With these fringe configurations, sometimes the passenger can use the airborne communication system, but will have a poor experience of the airborne e-mail service, and sometimes the passenger cannot use the airborne communication system, depending on the particular fringe configuration that the passenger is using.

It is reasonable to expect that those passengers who have fringe configurations and who want to use the e-mail service provided by the airborne communication system will want to do so in a way that is as close as possible to the way they use e-mail services when they are on the ground. For this reason, it is desirable to allow the passenger to use the e-mail service of the airborne communication system without requiring the passenger to change his/her fringe configuration to a common configuration before using the airborne e-mail service and consequently without requiring the passenger to change back to his/her fringe configuration when he/she lands.

In addition, some passengers have e-mail accounts on a variety of e-mail server types (e.g., Microsoft Exchange, Lotus Notes, GroupWise). When on the ground, in order to access the e-mail on these multiple accounts, such a passenger typically must change their e-mail client and/or e-mail client configuration when moving from one e-mail account to another. It is desirable for an airborne communication system to improve the passenger's experience of e-mail services when using the e-mail service provided by the airborne communication system. Thus, it is desirable to allow the passenger to access e-mail from multiple accounts, when using the airborne communication system, without requiring the passenger to change their e-mail client and/or e-mail client configuration when moving from one e-mail account to another.

### BRIEF SUMMARY OF THE INVENTION

The present invention is directed to a system and method for electronic communication management onboard an airborne aircraft. In one aspect, the system is designed to permit the electronic message communication between the passenger computing device operated by a passenger and a ground-based electronic messaging system via a wireless communication link. It comprises an airborne computing device on the aircraft to communicate with the passenger computing device while on board the aircraft and a proxy server to convert airborne mail commands to e-mail commands corresponding to the passenger e-mail service provider, thereby permitting the passenger to access the passenger e-mail account.

In one embodiment, the proxy server is located on the ground and the system further comprises radios to establish the wireless link. In this embodiment, the radios transmit the airborne mail commands to the ground-based proxy server for conversion to e-mail commands. Alternatively, the proxy server may be located on board the aircraft. In this embodiment, the radios transmit the e-mail commands corresponding to the passenger e-mail service provider.

In one embodiment, the airborne mail commands are JavaMail commands. The proxy server may parse data returned from the passenger e-mail account to extract data for display on the passenger computer. The parsed data may comprise e-mail summary information. The system may also comprise a ground-based radio to transmit partial information related to e-mail messages for the passenger. The partial information may be related to e-mail messages and comprise cost data indicative of a cost to transfer e-mail messages to the aircraft.

In another aspect of the invention, a system is provided to manage electronic communication between the airborne computer operated by the passenger and the ground-based electronic messenging system. In this aspect, an airborne computing device on the aircraft receives partial information related to electronic messaging for the passenger. The airborne computing device has an output portion that routes the received partial information to the passenger's computer, and an input portion that receives selection data from the passenger computer.

The selection data indicates electronic messages and/or electronic message attachments that the passenger wishes to have transmitted via the wireless link to the aircraft for delivery to the passenger computer. The partial data may comprise e-mail information related to at least one of a list of e-mail information comprising an e-mail sender, an e-mail subject, and e-mail attachments. The partial information may be related to size data indicative of a size of an e-mail and e-mail attachment, if any. The partial data may also include transfer cost information indicative of a cost to transfer an e-mail and/or e-mail attachment.

### BRIEF DESCRIPTION OF THE DRAWINGS

FIG. 1 is a diagram illustrating a suitable system in which aspects of the invention may operate.

FIG. 2, shows the protocols and technologies used when the base station communicates with a web enabled e-mail server.

FIGS. 3 through 9 are computer screen shots for depicting the system interaction without the invention.

FIGS. 10 through 16 are computer screen shots for depicting aspects of the invention.

Note: the headings provided herein are for convenience and do not necessarily affect the scope or interpretation of the invention.

### DETAILED DESCRIPTION OF THE INVENTION

The present invention is directed to a technique that allows almost all passengers access to their land-based e-mail accounts from an aircraft. This service is provided without having to install specialized software on the passenger's computer and, further, permits the passenger to retrieve e-mail from multiple accounts (e.g., a business account and a personal account).

Certain existing software products permit a user to access multiple e-mail accounts. One product, a POP3Connector, allows a user who has multiple web-based e-mail accounts to view them all through a single POP3 e-mail client. That is, the user does not have to change e-mail client and/or e-mail client configuration when accessing e-mail from one web-based e-mail account and then accessing e-mail from a different web-based e-mail account. The POP3Connector product aggregates a user's e-mail from multiple accounts only from multiple web-based e-mail accounts to a single POP3 e-mail client. In contrast, the present invention permits such access from on-board an aircraft and further provides the aggregated e-mail from multiple e-mail and web-based e-mail accounts to a single web-based e-mail client.

It is also desirable for the e-mail service provided by the airborne communication system to be integrated with the Intelligent Mail Management (IMM) and Instant Notification messages/URL links of the communication infrastructure in order to provide a simple, but comprehensive e-mail service. The Intelligent Mail Management (IMM) of the present invention provides control to the passengers to select which e-mails and/or attachments they receive and thus pay for while in-flight. This prevents the potential of passengers incurring costs for e-mails and/or their attachments that are extremely large and thus costly or for e-mails that they do not require to read whilst in-flight. The Instant Notification messages/links provide message or URL links to information web pages informing the passenger of arrival of new e-mails, the need to authorize e-mails or certain system problems.

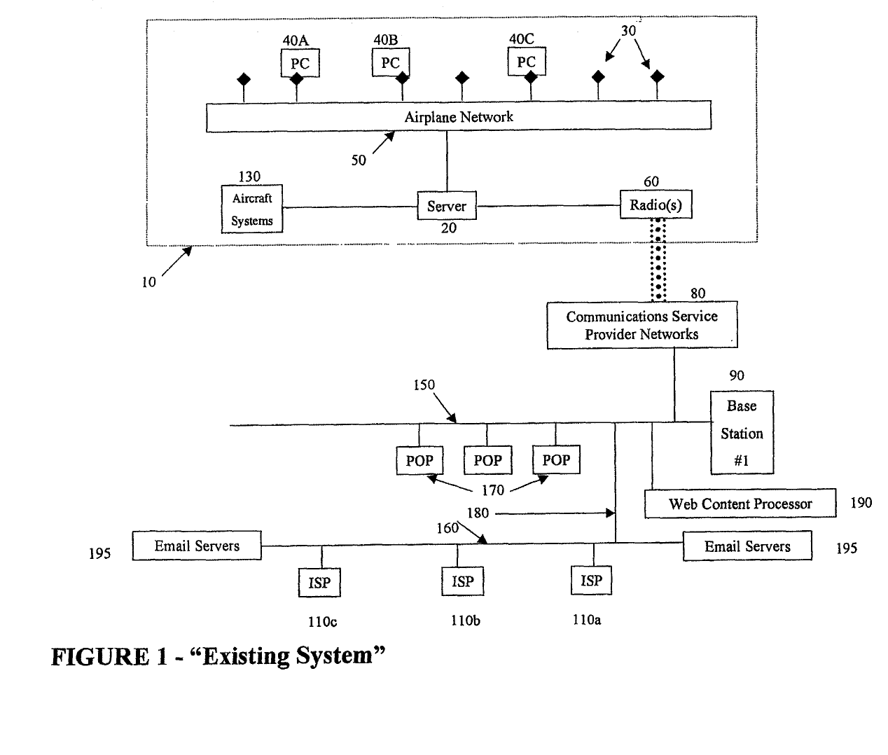

Referring to FIG. 1, a system for permitting passengers on board an aircraft to send and receive electronic data. Such a system is described in greater detail in U.S. patent application Ser. No. 09/487,752, entitled “Communications Systems for Aircraft,” filed Jan. 19, 2000, based on a PCT application published as WO 00/14987 on Mar. 16, 2000. The communication system described in the above-cited reference may be referred to herein as the “communication infrastructure.” The present invention relates to an electronic communication application that may be implemented using, by way of example, the communication infrastructure described in the cited reference. Those skilled in the art will recognize that other communication components may be used to supplant one or more portions of the example communication infrastructure. Therefore, the present invention is not limited by the specific components used to implement the example communication infrastructure.

Those parts of the system located on board the aircraft are shown within the region bounded by broken lines and labeled 10 in FIG. 1. The components of the system on board the aircraft include a server 20 having a plurality of nodes 30 to which computer terminals 40a, 40b and 40c are attached, as desired. The computer terminals in the embodiment shown are laptop or palm-top personal computers belonging to the various passengers on board. As will be described in greater detail below, the server 20 communicates with a wide variety of different terminals running different operating systems. Each computer terminal is connected to the server 20 via an aircraft network 50.

The server 20 has mass storage which contains a database of WWW pages which can be browsed by passengers using their computer terminals 40a, 40b and 40c. Server 20 provides a domain name server (DNS) that masquerades as the passenger's usual DNS. Server 20 then links the passenger to the appropriate locally stored WWW page. The server 20 also contains storage for e-mail messages.

Connected to the server 20 is one or more radios 60. The radio(s) 60 provide a two-way wireless communication link with ground-based portions of the communication infrastructure and permits data to be transferred to base station 90, using communications networks 80.

A virtual private network (VPN) 150 connects base station 90 to communications service provider networks 80, web content processor 190, and via links 180 to the Internet 160. Points of Presence (POP) 170 provide Internet access and e-mail service to subscribers of the service while not on the aircraft. POPs 170 can also be used by communications service provider networks and web content processors as an alternate means to connect to VPN 150.

Base station 90 connects to Internet service provider (ISP) or corporate mail servers 110a, 110b and 110c, which host the mail servers of the respective passengers on board the aircraft who are connected to server 20.

Thus electronic mail sent from terminal 40a on board the aircraft is first forwarded to server 20 where it is stored. The server determines the appropriate time to initiate a data exchange with base station 90. This can be when sufficient data is awaiting transmission from server 20, or when the time since the last exchange exceeds a time limit (e.g., 15 minutes), or when base station 90 signals to server 20 via communications service provider network 80 and radio 60. Any e-mail messages stored on server 20 since the previous connection was made are then transmitted to base station 90. The base station 90 forwards each e-mail message on to their eventual destinations Mail servers 195.

While this disclosure describes electronic mail or web pages as being sent from servers to computer, servers usually retain the electronic mail message and web pages, and allow the electronic mail and web browser client applications (which may reside on the computer terminal or on the same server) to fetch a copy of, or view, the electronic mail or web pages. The electronic mail and web browser client applications allow the user to view the data (which is typically stored on the server, not on the computer terminal) using the computer terminal.

In one embodiment, base station 90 signals server 20 with a trigger signal which indicates that data in the form of e-mail messages is stored by the station and awaits retrieval. The server 20 establishes a communication link with the base station 90 to retrieve this data, which is then transmitted to the server.

In a further embodiment, data is transmitted from server 20 to base station 90 at intervals based on predetermined periods of time that the aircraft has been in flight.

Similarly, any messages generated by the user of terminal 40b are also sent to server 20 for storage, and forwarded to base station 90 along with the stored messages from the other passengers. The base station 90 then forwards messages from the computer terminal 40b on to their eventual destinations as well.

The general procedure for obtaining e-mail messages from the Internet service providers or corporate accounts of the various passengers is similar to the procedure for sending e-mail messages from the various terminals 40a-40c on the aircraft. Once a passenger connects a PC to aircraft network 50 and then connects to server 20, the passenger initiates e-mail retrieval. Server 20 accepts the request for e-mail and collects the passenger Mail server address, user id and password. If necessary, a corporate subscriber can activate previously setup firewall services, and provide additional username and password information. This information is passed to base station 90 via radio 60 and communications service provider networks 80. Base station 90 contacts ISPs/corporate servers 110a,b,c and collects any e-mail for the passengers using their user IDs and passwords. Base station 90 continues to collect e-mail from ISPs/corporate servers 110a,b,c for the duration of the flight that the passengers are on. When a connection is established between server 20 on board the aircraft and base station 90, that stored e-mail message or messages are transmitted from base station 90 to server 20. This procedure is usually simultaneous with the transmission of e-mail messages in the other direction from server 20 to base station 90.

Once e-mail messages have been received at server 20, they are retrieved by the respective passenger's computer terminals, 40a and 40b via the aircraft network 50 when the passenger subsequently connects to server 20 and retrieves mail.

The system includes a single base station. However, in other embodiments the system includes a number of base stations located at spaced apart locations on the surface of the planet.

Returning to the system of FIG. 1, as the aircraft flies from its departure airport towards the destination airport, aircraft system 130 indicates to server 20 the location of the aircraft at regular intervals.

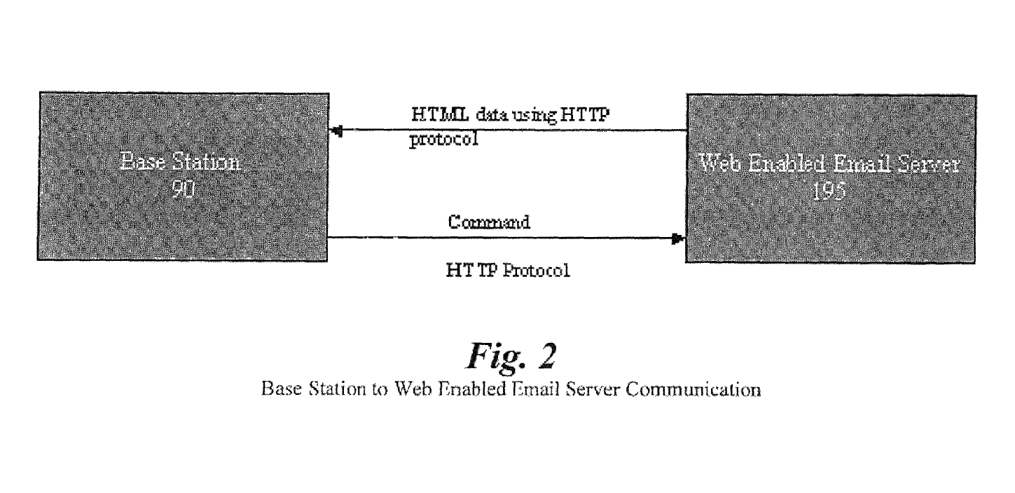

In the context of the present invention, a “proxy” is a set of software instructions and/or functionality that is substituted for some underlying functionality. The present invention provides proxy functionality in two aspects. On board the aircraft, the server 20 provides proxy functionality for the passenger's normal messaging service provider. That is, from the point of view of the passenger's computing device (e.g., the terminals 40a-c of FIG. 1) the server 20 functions as a proxy for the messaging service provider for the individual passengers. In a second aspect, the base station 90 functions as a proxy for the passenger terminals with respect to the message service provider (e.g., the ISPs/corporate servers 110a-c). It is this proxy operation that allows communication between the passenger computing devices and their respective message service providers to occur without real-time connection between the passenger computer and the message service provider. Having provided a brief overview of the system, a detailed description of the software and hardware of the system will now be provided with reference to the FIGS. 2-16.

Through their standard web browser running on their computer terminal 40a-c, the passenger chooses to use the web-based e-mail client native to the communication infrastructure. The ‘account set up’ part of the web-based e-mail client guides the passenger to configure the web-based e-mail client to use their existing POP3, SPOP3, IMAP e-mail accounts and e-mail accounts whose e-mail servers have been web enabled. These account details including the secure server information, mail server name, username and password are all stored as standard ‘cookies’ in the web browser and are only entered once at initial set up of the web-based e-mail client. The use of cookies is well known in computer technology and need not be described in greater detail herein. However, it should be noted that the use of a cookie to store information on the individual passenger computer is for convenience of the passenger in subsequent travels. The cookie stores the setup information such that the user need only enter it one time. During subsequent travels, the cookie automatically provides the necessary account setup information, thus simplifying e-mail communication for the passenger. However, the cookie is for convenience only and is not necessary for satisfactory operation of the system.

Using the web-based e-mail client the passenger selects to start receiving e-mail from any or all e-mail accounts set up in the web-based e-mail client. Upon retrieval selection the secure server information, mail server name, username and password are passed between the computer terminal 40a-c and the airborne server 20. Notice that the web-based e-mail client native to the communication infrastructure does not require any new software to be downloaded to the passenger's laptop 40 as the e-mail system runs from the airborne server 20 of the communication infrastructure.

The airborne server 20 communicates to the base station 90 through radio(s) 60 and Communications Service Provider Networks 80 (as per the communication infrastructure) and passes the secure server information, mail server name, username and password for each passenger e-mail account. Although not essential for proper operation of the system, it should be noted that the airborne server does not store passenger passwords in order to provide enhanced e-mail security.

The present invention provides that application program interface (API) that translates airborne commands (i.e., commands from the passenger computing device) to commands corresponding to the particular message service provider for each passenger. The base station 90 performs its standard proxy service using the communication infrastructure for the industry standard POP3 and SPOP3 e-mail servers 170 and for ISP's 110a-c that also use these standard e-mail servers. The API used for communication protocols such as POP3 and SPOP3 are known in the art and need not be described in greater detail herein.

The base station 90 performs its enhanced proxy service for any and all e-mail servers being accessed by passengers that are web enabled. Referring to FIG. 2, base station 90 accesses the web enabled e-mail server 195 by sending commands over the Internet using the standard HTTP protocol. The web enabled e-mail server 195 communicates back to the base station 90 over the Internet as it would any web browser sending HTML data in response to the base station 90 commands also using the standard HTTP protocol.

The base station 90 performs its enhanced proxy service for sending e-mails (i.e., sending an e-mail from the passenger computer aboard the aircraft) as follows: The passenger composes an e-mail, including adding attachments, using the web-based e-mail client. The composed e-mail is sent from their computer terminal 40a-c to the airborne server 20. The Intelligent Mail Management (IMM) ensures the e-mail does not exceed the configured e-mail size and quota limits. The airborne server 20 communicates to the base station 90 through radio(s) 60 and Communications Service Provider Networks 80 and transfers the composed e-mail as part of any other aggregated e-mails and messages.

The API for web-enabled access may be custom designed for different service providers. In one embodiment, an industry standard protocol, known as JavaMail, is used as the set of airborne commands (i.e., commands from the passenger computing devices), which are converted into web-enabled commands to access the respective passenger's messaging service provider. The base station 90 using the JavaMail mapping shown in Tab.le 1 sets up the appropriate URL connection to the web enabled e-mail server 195.

TABLE 1
MAPPING JAVAMAIL COMMANDS
TO WEB ENABLED SERVER COMMANDS

| | | Web Enabled Server |
|---|---|---|
| Action | JavaMail Commands | Commands |
| Retrieve Mail | Create store(http) or secure | Enter URL into browser |
| | store(https) | Login with username and |
| | Connect to store with | password |
| | hostname, port, username and | |
| | password | |
| | Get ‘Inbox’ folder | Read ‘Inbox’ Summary |
| | Open ‘Inbox’ folder | |
| | Get a message from folder | Read Message |
| | Read appropriate information | |
| | from message | |
| | Close Store | Log off |
| Send Mail | Create store(http) or secure | Enter URL into browser |
| | store(https) | Login with username and |
| | Connect to store with | password |
| | hostname, port, username and | |
| | password | |
| | Create new message | Create new message |
| | Add attachment (when | Add attachment (when |
| | applicable) | applicable) |
| | Send Message | Send Message |
| | Close transport | Log off |

The base station 90 using the JavaMail mapping shown in Table 1 logs in to the web enabled e-mail server 195 using the passenger's username and password. The base station 90 using the JavaMail mapping shown in Table 1 transposes the composed e-mail received from the airborne server 20 to create a new message and add attachment(s) (if in the original message) and sends the message through the web enabled e-mail server 195 just as if the passenger was using a web browser directly with the web enabled e-mail server 195.

The base station 90 using the JavaMail mapping shown in Table 1 optionally logs off of the web enabled e-mail server 195 or remains logged in until either another message is received by the base station 90 from the passenger via the airborne server 20 to be sent or the web enabled e-mail server 195 automatically logs off base station 90 due to inactivity. Notice that when the passenger sends e-mail using this invention a copy of the e-mail will be found in their ‘sent box’ stored on the web enabled server just as if they had sent it while on the ground. Thus, the system provides displays that, from the passenger's perspective, appear to be virtually identical to displays that would appear if the passenger were using a conventional web-based e-mail access. That is, the user's interaction with the onboard system mimics the user's interaction with a convention web-based e-mail system.

The base station 90 performs its enhanced proxy service for receiving e-mails (i.e., receiving e-mails intended for the passenger on board the aircraft) as follows: When the passenger initially requests to receive e-mail using the web-based e-mail client, the airborne server 20 relays this request to the base station 90 through radio(s) 60 and Communications Service Provider Networks 80 (as per the communication infrastructure). As part of the ‘receive request’ the secure server information, mail server name, username and password for the passenger e-mail account is also captured by the airborne server 20 from the computer terminal 40a-c and sent to the base station 90. The base station 90 using the JavaMail mapping shown in Table 1 sets up the appropriate URL connection to the web enabled e-mail server 195. The base station 90 using the JavaMail mapping shown in Table 1, logs in to the web enabled e-mail server 195 using the passenger's username and password. The base station 90 using the JavaMail mapping shown in Table 1 performs a Read Inbox Summary command on the web enabled e-mail server 195 and reads a configurable latest number of e-mails from the InBox.

The base station 90 parses all the e-mails read from the Inbox and using Intelligent Mail Management (IMM), described in the above-referenced patent publication, generates the e-mail header and attachment information for each e-mail in the Inbox. The base station 90 aggregates this information along with other messages and data to be transmitted to the aircraft. On the next established communications session between the base station 90 and the airborne server 20 these messages are transferred from the base station 90 to the airborne server 20.

The airborne server 20 sends an Instant Notification message to the passenger's computer terminal 40a-c. The Instant Notification provides a URL that can be selected by the passenger using a web browser directing them to the Intelligent Mail Management web pages. Using Intelligent Mail Management the passenger selects which e-mails they want to receive in-flight. The airborne server 20 communicates this information to the base station 90 during the next established communications session.

The base station 90 using the JavaMail mapping shown in Table 1 performs a Read Message command on the web enabled e-mail server 195 for each requested e-mail including any requested attachments. The base station 90 aggregates the requested e-mails/attachments along with other messages and data to be transmitted to the aircraft. On the next established communications session between the base station 90 and the airborne server 20 these messages are transferred from the base station 90 to the airborne server 20.

Upon receipt of the requested e-mails/attachments, the airborne server 20 sends an Instant Notification message to the passenger's computer terminal 40a-c informing the passenger that the new e-mails are available to be read. The passenger using the web-based e-mail client reads the e-mails from the airborne server 20. Thus, the system provides displays that, from the passenger's perspective, appear to be virtually identical to displays that would appear if the passenger were using a conventional web-based e-mail access. That is, the user's interaction with the onboard system mimics the user's interaction with a convention web-based e-mail system.

It should be noted that the proxy functions performed by the base station 90 (see FIG. 1) may be translated by the airborne server 20. That is, the API commands (e.g., the JavaMail commands of Table 1) may be performed by the airborne server 20, the base station 90, or both, in combination. The present invention is not limited by the specific location of the computing device performing the necessary command translations.

The aggregated e-mails collected from various internet service providers (e.g., ISPs 110a-110c) are typically aggregated at the base station 90. In one embodiment, the aggregated e-mails may be transmitted to the airborne server 20 for delivery to the passengers. However, in an exemplary embodiment, the aggregated e-mails are collected at the base station 90 and only an e-mail summary is transmitted to the airborne server 20. This advantageously limits the amount of data transmitted to the airborne server, thus, advantageously limiting the cost to the passenger. As will be described in greater detail, the passenger can select which e-mails and/or attachments should be transmitted. This embodiment gives the user control over the amount of data transferred to the airborne server and the cost associated therewith.

The web-based e-mail client native to the communication infrastructure interacts with the IMM feature of the communication infrastructure as described below. The IMM is used to manage the collection and delivery of e-mails including the management of any attachments to the e-mails. The IMM feature analyses e-mail messages to identify the various components of the message. For example, if an e-mail message includes a text body from sender John Doe and two attachments, the first having a size of 2 Kb, the second having a size of 4 Mb and the third having a size of 6 Mb, these components are identified to server 20. It may be, of course, that the passenger chooses not to receive these very large attachments if, for example, they entail an additional expense. Thus, the IMM feature sends a summary of the e-mail received at the base station 90 from the passenger's mail server to the passenger's computer terminal 40a-c on board the aircraft. That is, once this summary has been received by the airborne server 20, it is forwarded to the specified passenger, using either the HTTP protocol, the POP3 protocol or any other suitable protocol.

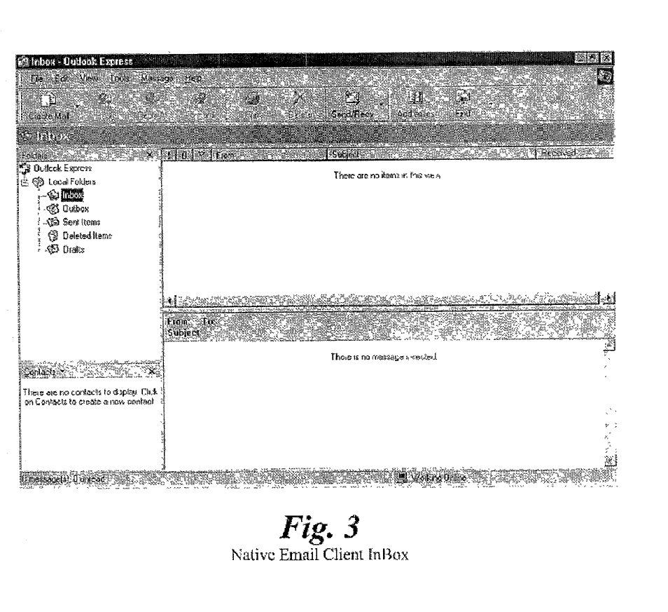

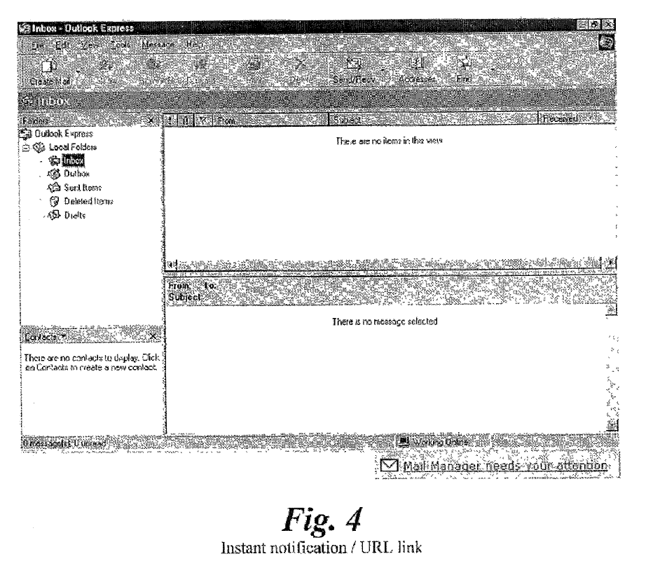

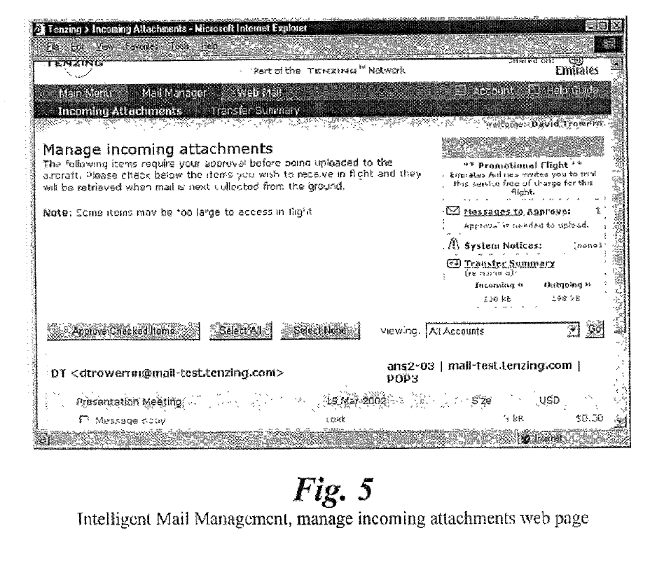

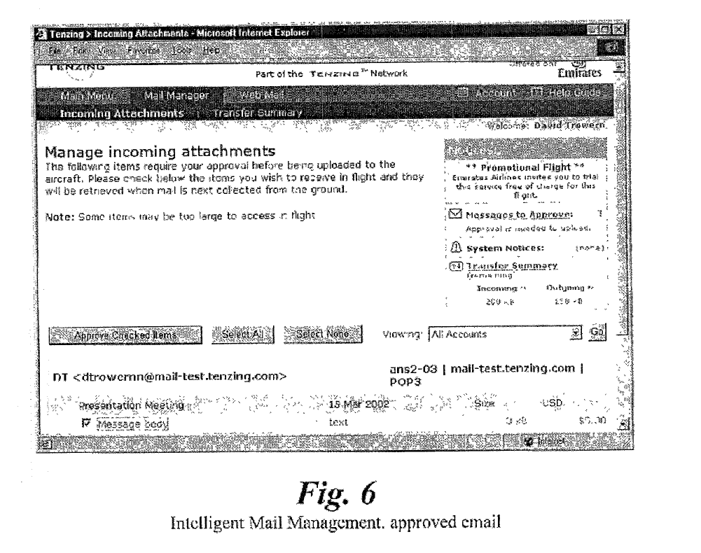

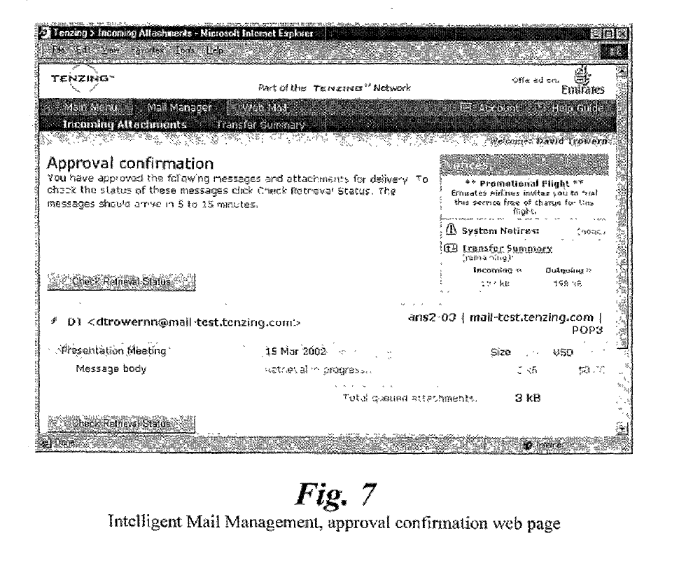

Without the proxied web-based e-mail of the present invention, a typical sequence of events using Intelligent Mail Management (IMM) might be as follows. The passenger has their native e-mail client application open on their computer terminal 40a-c, specifically the In Box folder (see FIG. 3). The system generates an instant notification message/URL link on the passenger's computer terminal 40a-c (see FIG. 4). Selecting this URL link the Manage incoming attachments web page is displayed to the passenger on their computer terminal 40a-c notifying them that authorization is required in order to receive an e-mail and/or its attachments that is above the receive e-mail threshold (see FIG. 5). Notice the web page advises the passenger of the size and cost of any selected e-mail and/or attachments. The passenger authorizes the e-mail message body and/or attachment(s) by selecting the check box against the required e-mail messages and/or attachments and selecting the Approve Checked Items button (see FIG. 6). The web browser on the computer terminal 40a-c notifies the airborne server 20 of the selected e-mail message components (body and attachments) to be retrieved for the passenger. The airborne server 20 communicates this information to the base station 90 during the next established communications session 20 and also sends an Approval confirmation web page to the passenger's computer terminal 40a-c which is displayed by the native web browser (see FIG. 7).

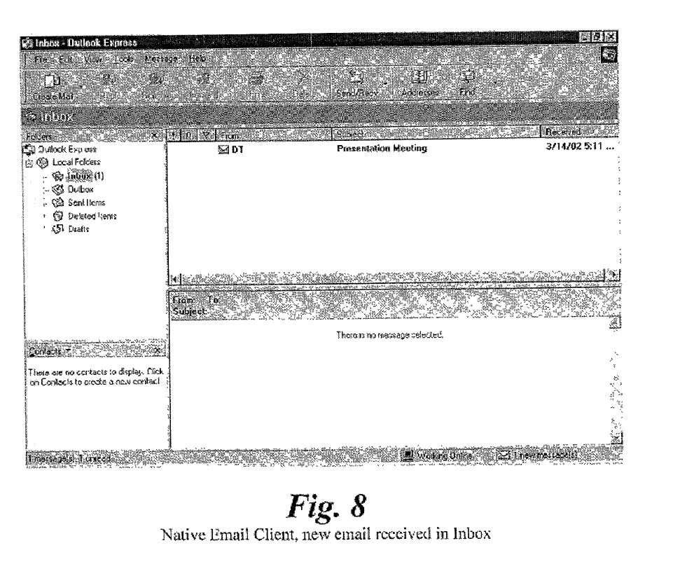

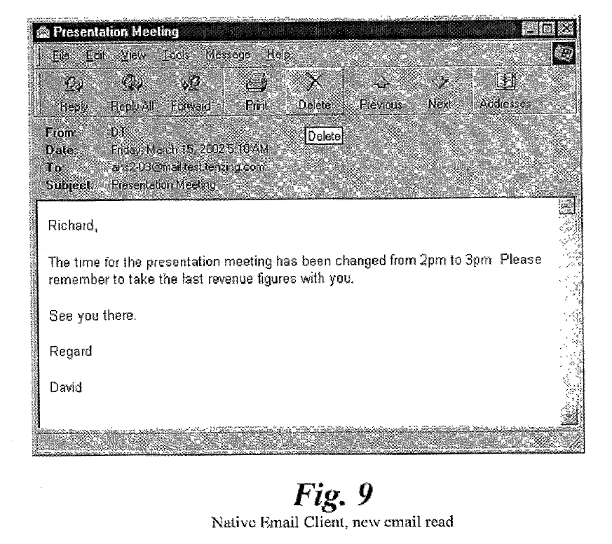

The base station 90 retrieves and aggregates the selected e-mail messages (body and attachments) along with other messages and data to be transmitted to the aircraft. These messages are transferred from the base station 90 to the airborne server 20. The airborne server 20 sends an instant notification message to the passenger's computer terminal 40a-c informing the passenger that new e-mails are available to be read. The passenger navigates to the In Box folder on their native e-mail client on the computer terminal 40a-c, and selects to receive/read any new e-mails. The airborne server 20 sends the new e-mails to the passenger's computer terminal 40a-c as requested by the native e-mail client (see FIG. 8). The passenger then opens the new e-mail message using the native e-mail client (see FIG. 9). Notice that the passenger has to switch back and forth between the native e-mail client and the native web browser client. Switching back and forth between applications is tedious for the passenger and results in an unsatisfactory experience in sending and receiving e-mails onboard an aircraft.

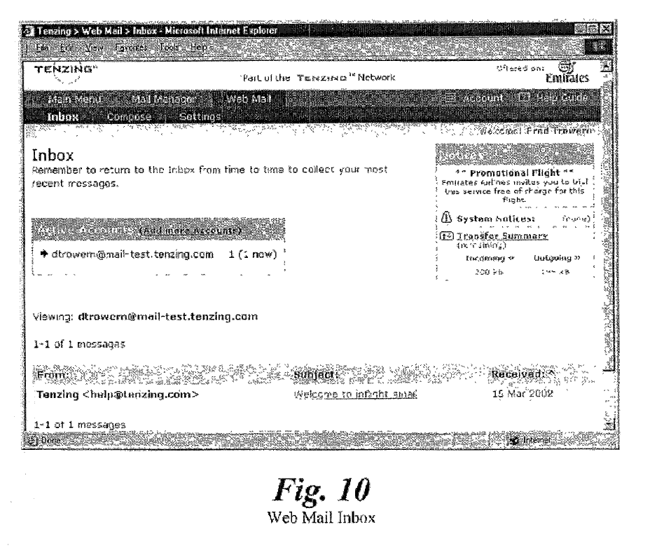

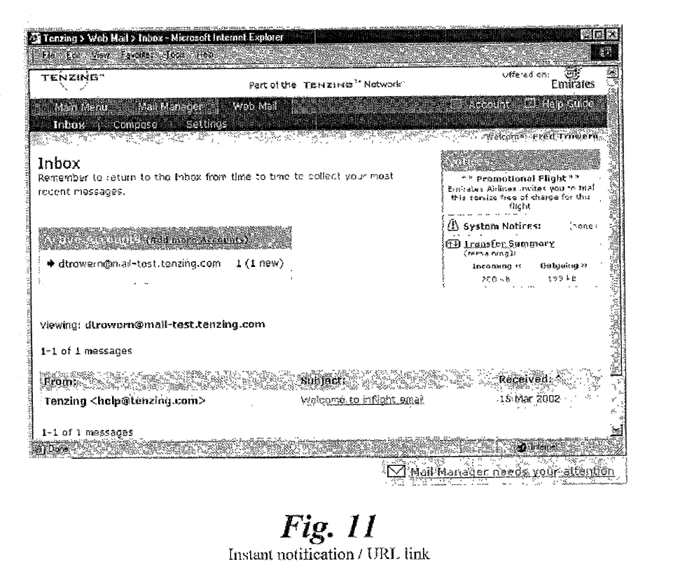

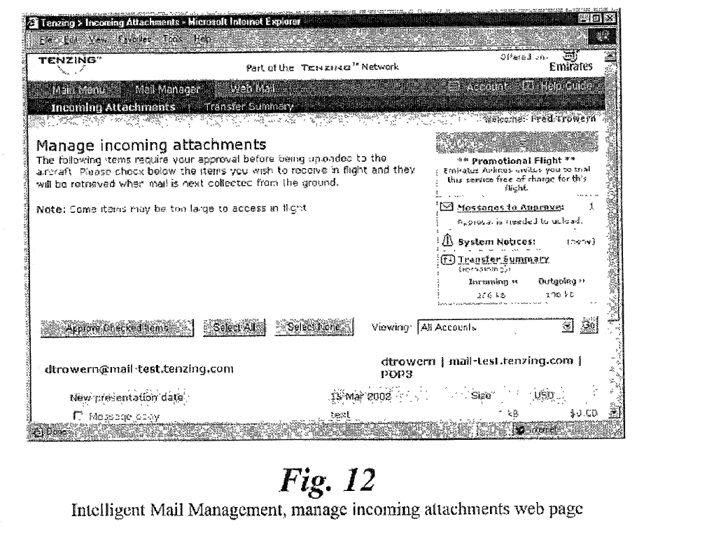

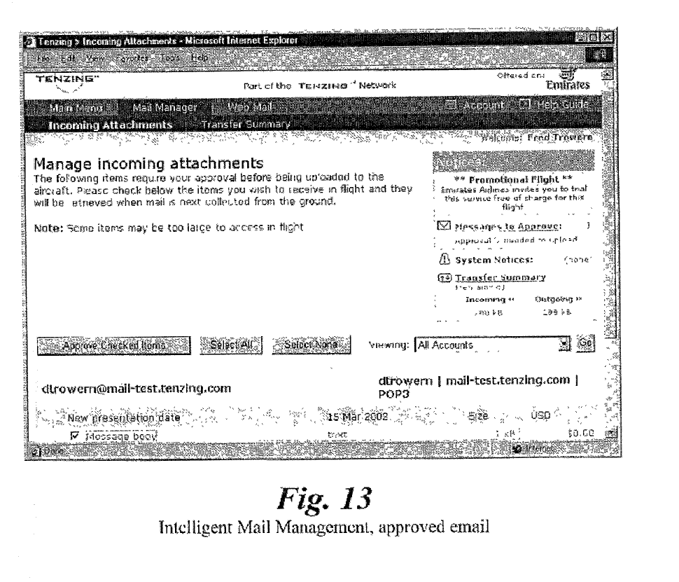

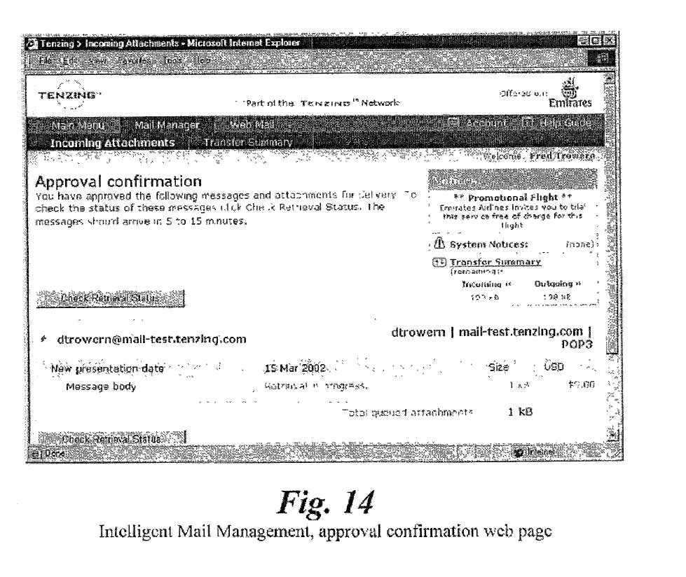

By contrast, with the proxied web-based e-mail of the present invention, the above typical sequence of events shrinks to the following. The passenger has the web-based e-mail client native to the communication infrastructure open on their computer terminal 40a-c, specifically the In Box web page (see FIG. 10). The system generates an instant notification message/URL link on the passenger's computer terminal 40a-c (see FIG. 11). Selecting this URL link the “Manage incoming attachments” web page is displayed to the passenger on their computer terminal 40a-c notifying them that authorization is required in order to receive an e-mail and/or its attachments that is above the receive e-mail threshold (see FIG. 12). Notice the web page advises the passenger of the size and cost of any selected e-mail and/or attachments. The passenger authorizes the e-mail message body and/or attachment(s) by selecting the check box against the required e-mail messages and/or attachments and selecting the Approve Checked Items button (see FIG. 13). The web browser on the computer terminal 40a-c notifies the airborne server 20 of the selected e-mail message components (body and attachments) to be retrieved for the passenger. The airborne server 20 communicates this information to the base station 90 during the next established communications session 20 and also sends an Approval confirmation web page to the passenger's computer terminal 40a-c which is displayed by the native web browser (see FIG. 14).

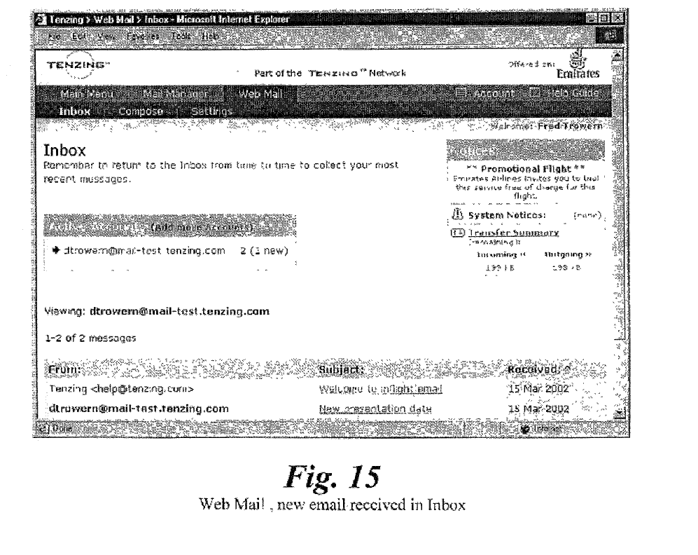

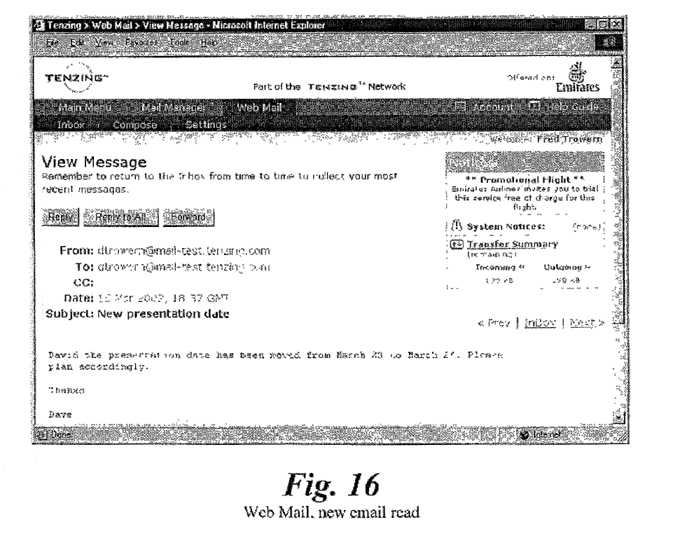

The base station 90 retrieves and aggregates the selected e-mail messages (body and attachments) along with other messages and data to be transmitted to the aircraft. These messages are transferred from the base station 90 to the airborne server 20. The airborne server 20 sends an instant notification message to the passenger's computer terminal 40a-c informing the passenger that the new e-mails are available to be read. The passenger navigates to the In Box of the system's native web-based e-mail client (see FIG. 15), on the computer terminal 40a-c, and can select to read any new e-mails. The passenger then opens the new e-mail message using the native web-based e-mail client (see FIG. 16). Notice that all actions are performed using a single native web browser. This process eliminates the need for switching between the native e-mail client and the native web browser client and, thus, greatly enhances the passenger's electronic communication experience onboard the aircraft.

Alternatively, the passenger can defer delivery of e-mail message components until the passenger has left the aircraft and established an alternative connection to the relevant ISP/mail server.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural or singular number, respectively. Additionally, the words “herein,” “above” and “below” and words of similar import, when used in this application, shall refer to this application as a whole and not to any particular portions of this application.

The description of embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. For example, while functions or components are presented in a given order, alternative embodiments may perform functions, implement components in a different order, or functions may be performed substantially concurrently or components implemented in a parallel fashion. The teachings of the invention provided herein can be applied to other systems, not only the system described herein. The various embodiments described herein can be combined to provide further embodiments.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the invention can be modified, if necessary, to employ the systems, functions and concepts of the various patents and applications described above to provide yet further embodiments of the invention.

Aspects of the invention can be modified, if necessary, to employ the systems, functions and concepts of the above references and application to provide yet further embodiments of the invention. These and other changes can be made to the invention in light of the detailed description.

What is claimed is:

1. A wireless electronic messaging system for use in an aircraft, comprising:
a ground-based server;
an airborne server on the aircraft;
a wireless up-link communicatively coupled to the ground-based server and the airborne server;
a display unit visible to an end-user to display partial information related to electronic messaging; and
an input unit responsive to the user to select electronic messaging components for transmission from the ground-based server to the airborne server.

2. The system of claim 1, further comprising a wireless down-link communicatively coupled to the airborne server and the ground-based server wherein the airborne server transmits user selection data to the ground-based server.

3. The system of claim 2 wherein the ground-based server forwards selected components of the electronic messaging to the airborne server via the up-link based on the user selection data.

4. The system of claim 1 wherein the partial information comprises electronic mail (email) information related to at least one of a list of email information comprising an email sender, an email subject, and email attachments.

5. The system of claim 4 wherein the partial information related to email comprises size data indicative of a size of an email and/or an email attachment.

6. The system of claim 4 wherein the partial information related to email attachments comprises cost data indicative of a cost to transfer an email and/or email attachment via the up-link.

7. The system of claim 1 for use with multiple end-users, the system further comprising a display and a corresponding input unit for each of the plurality of end-users wherein one of the display units is visible to each of the end-user to display partial information related to electronic messaging for the individual end-user and the corresponding input unit is operable by the individual end-user to select electronic messaging components for the individual end-user.

8. A wireless electronic messaging system for use in an aircraft to permit electronic message communication between an airborne computer operated by a passenger and a ground-based electronic messaging system via a wireless communication link, comprising:
an airborne computing device on the aircraft to receive partial information related to electronic messaging for the passenger;
an output portion of the airborne computing device to route the received partial information to the passenger's computer; and
an input portion of the airborne computing device to receive selection data from the passenger computer.

9. The system of claim 8, further comprising a transmitter coupled to the airborne computing device to transmit the selection data to the ground-based electronic messaging system via the wireless communication link.

10. The system of claim 8 wherein the airborne computing device receives selected components of the electronic messaging via the wireless communication link based on the user selection data.

11. The system of claim 8 wherein the partial information comprises electronic mail (email) information related to at least one of a list of email information comprising an email sender, an email subject, and email attachments.

12. The system of claim 10 wherein the partial information is related to size data indicative of a size of an email and email attachment, if any.

13. The system of claim 10 wherein the partial information related to email attachments comprises cost data indicative of a cost to transfer an email and email attachment, if any, via the up-link.

14. A wireless electronic messaging system for use in an aircraft to permit electronic message communication between a passenger computing device operated by a passenger and a ground-based electronic messaging system via a wireless communication link, comprising:
an airborne computing device on the aircraft to communicate with the passenger computing device while onboard the aircraft; and
a proxy server to convert airborne mail commands to email commands corresponding to the passenger email service provider to thereby permit the passenger to access a passenger email account.

15. The system of claim 14 wherein the proxy server comprises a ground-based proxy server portion to serve as a proxy for the passenger computing device with respect to the passenger service provider.

16. The system of claim 14 wherein the proxy server comprises an airborne proxy server portion to serve as a proxy for the passenger service provider with respect to the passenger computing device.

17. The system of claim 14 wherein the airborne mail commands are JavaMail commands.

18. The system of claim 14 wherein the proxy server parses data returned from the passenger email account to extract data for display on the passenger computer.

19. The system of claim 18 wherein the parsed data comprises email summary information.

20. The system of claim 14, further comprising an airborne receiver to receive partial information related to email messages for the passenger.

21. The system of claim 20 wherein the partial information related to email messages comprises cost data indicative of a cost to transfer email messages to the aircraft.

22. The system of claim 14 wherein the passenger email service provider provides web-based access to the passenger email account, the proxy server converting the airborne mail commands to web-based commands to enable passenger access to the passenger email account.

23. The system of claim 14 wherein the passenger email service provider provides access to the passenger email account using an industry standard comprising a selected one of POP3 and SPOP3, the proxy server converting the airborne mail commands to commands for the selected industry standard to enable passenger access to the passenger email account.

24. A wireless electronic messaging system for use in an aircraft to permit electronic message communication between an airborne computer operated by a passenger and a ground-based electronic messaging system via a wireless communication link, comprising:
airborne means for receiving partial information related to electronic messaging for each of a plurality of passengers;
routing means for routing the received partial information to the respective passenger's computer; and
means for receiving selection data from the computer of at least one passenger.

25. The system of claim 24, further comprising means for transmitting the selection data to the ground-based electronic messaging system via the wireless communication link.

26. The system of claim 24, further comprising means for receiving selected components of the electronic messaging via the wireless communication link based on the user selection data.

27. The system of claim 24 wherein the partial information comprises electronic mail (email) information related to at least one of a list of email information comprising an email sender, an email subject, and email attachments.

28. The system of claim 24 wherein the partial information related to email attachments comprises size data indicative of a size of an email and email attachment, if any.

29. The system of claim 24 wherein the partial information related to email attachments comprises cost data indicative of a cost to transfer an email and an email attachment, if any, via the up-link.

30. A wireless electronic messaging system for use in an aircraft to permit electronic message communication between a passenger computing device operated by a passenger and a ground-based electronic messaging system via a wireless communication link, comprising:
means for coupling an airborne computing device with the passenger computing device while onboard the aircraft;
means for converting airborne mail commands to email commands corresponding to the passenger email service provider to thereby permit the passenger to access a passenger email account; and
means for communicating between the aircraft and a ground-based station.

31. The system of claim 30 wherein the means for converting comprises a ground-based portion to serve as a proxy for the passenger computing device with respect to the passenger service provider.

32. The system of claim 30 wherein the means for converting comprises an airborne portion to serve as a proxy for the passenger service provider with respect to the passenger computing device is located on the aircraft and the means for communicating transmits the web-enabled email commands to the ground-based station.

33. The system of claim 30 wherein the airborne mail commands are JavaMail commands.

34. The system of claim 30 wherein the means for converting parses data returned from the passenger email account to thereby extract data for display on the passenger computer.

35. The system of claim 34 wherein the parsed data comprises email summary information and the means for coupling provides the passenger computing device with the email summary information.

36. The system of claim 30 wherein the means for communicating transmits information related to email messages for the passenger and an airborne radio to receive the information.

37. The system of claim 36 wherein the information related to email messages comprises cost data indicative of a cost to transfer email messages to the aircraft.

38. The system of claim 30 wherein the passenger email service provider provides web-based access to the passenger email account, the means for converting functioning to convert the airborne mail commands to web-based commands to enable passenger access to the passenger email account.

39. The system of claim 30 wherein the passenger email service provider provides access to the passenger email account using an industry standard comprising a selected one of POP3 and SPOP3, the means for converting functioning to convert the airborne mail commands to commands for the selected industry standard to enable passenger access to the passenger email account.

40. A computer-readable media to control wireless electronic messaging in an aircraft to permit electronic message communication between an airborne computer operated by a passenger and a ground-based electronic messaging system via a wireless communication link, comprising computer instructions that cause a computer to:
receive partial information related to electronic messaging for a passenger;
route the received partial information to the passenger's computer; and
receive selection data from the passenger computer.

41. The computer-readable media of claim 40, further comprising instructions to transmit the selection data to the ground-based electronic messaging system via the wireless communication link.

42. The computer-readable media of claim 40, further comprising instructions to receive selected components of the electronic messaging via the wireless communication link based on the passenger selection data.

43. The computer-readable media of claim 40 wherein the partial information comprises electronic mail (email) information related to at least one of a list of email information comprising an email sender, an email subject, and, if the email includes and email attachment, email attachments.

44. The computer-readable media of claim 40 wherein the partial information related to email comprises size data indicative of a size of an email and email attachment, if any.

45. The computer-readable media of claim 40 wherein the partial information related to email and email attachments, if any, comprises cost data indicative of a cost to transfer an email and email attachment, if any, via the up-link.

46. A computer-readable media for wireless electronic messaging system in an aircraft to permit electronic message communication between a passenger computing device operated by a passenger and a ground-based electronic messaging system via a wireless communication link, comprising computer instructions that cause a computer to:
couple an airborne computing device with the passenger computing device while onboard the aircraft;
convert airborne mail commands to email commands corresponding to the passengers email service provider to thereby permit the passenger to access a passenger email account; and
communicate between the aircraft and the ground-based station.

47. The computer-readable media of claim 46 wherein the airborne mail commands are JavaMail commands.

48. The computer-readable media of claim 46, further comprising instructions to cause the computer to parse data returned to from the passenger email to thereby extract data for display on the passenger computer.

49. The computer-readable media of claim 46 wherein the parsed data comprises email summary information and the computer instructions cause the computer to provide the passenger computing device with the email summary information.

50. The computer-readable media of claim 46 wherein the computer instructions cause the computer to transmits information related to email messages for the passenger and an airborne radio to receive the information.

51. The computer-readable media of claim 50 wherein the information related to email messages comprises cost data indicative of a cost to transfer email messages to the aircraft.

52. A method for wireless electronic messaging in an aircraft to permit electronic message communication between an airborne computer operated by a passenger and a ground-based electronic messaging system via a wireless communication link, comprising:
receiving partial information related to electronic messaging for each of a plurality of passengers;
routing the received partial information to the respective passenger's computer; and
receiving selection data from the computer of at least one passenger.

53. The method of claim 52, further comprising transmitting the selection data to the ground-based electronic messaging system via the wireless communication link.

54. The method of claim 52, further comprising receiving selected components of the electronic messaging via the wireless communication link based on the user selection data.

55. The method of claim 52 wherein the partial information comprises electronic mail (email) information related to at least one of a list of email information comprising an email sender, an email subject, and email attachments.

56. The method of claim 52 wherein the partial information related to email attachments comprises size data indicative of a size of an email and any email attachment.

57. The method of claim 52 wherein the partial information related to email attachments comprises cost data indicative of a cost to transfer an email and any email attachment via the up-link.

58. A method for electronic messaging in an aircraft to permit electronic message communication between a passenger computing device operated by a passenger and a ground-based electronic messaging system via a wireless communication link, comprising:
coupling an airborne computing device with the passenger computing device while onboard the aircraft;
converting airborne mail commands to email commands corresponding to the passenger's email service provider to thereby permit the passenger to access a passenger email account; and
communicating between the aircraft and a ground-based station.

59. The method of claim 58 wherein converting airborne commands is performed by a ground-based portion to serve as a proxy for the passenger computing device with respect to the passenger's email service provider.

60. The method of claim 58 wherein converting airborne commands is performed by an airborne portion to serve as a proxy for the passenger service provider with respect to the passenger computing device.

61. The method of claim 58 wherein the airborne mail commands are JavaMail commands.

62. The method of claim 58, further comprising parsing data returned to from the passenger email account to thereby extract data for display on the passenger computer.

63. The method of claim 62 wherein the parsed data comprises email summary information, the method further comprising providing the passenger computing device with the email summary information.

64. The method of claim 58 wherein a ground-based station transmits information related to email messages for the passenger, the method further comprising providing the information to the passenger computer.

65. The method of claim 64 wherein the information related to email messages comprises cost data indicative of a cost to transfer email messages to the aircraft.
